(19) United States
(12) Patent Application Publication
(10) Pub. No.: US 2016/0070879 A1
(43) Pub. Date: Mar. 10, 2016

(54) METHOD AND APPARATUS FOR DISEASE DETECTION

(71) Applicant: LOCKHEED MARTIN CORPORATION, Bethesda, MD (US)

(72) Inventors: John HATLELID, Boulder, CO (US); John R. Ludwig, JR., Norristown, PA (US); Stephen William O'Neill, JR., Philadelphia, PA (US); Mike Draugelis, Ardmore, PA (US)

(73) Assignee: LOCKHEED MARTIN CORPORATION, Bethesda, MD (US)

(21) Appl. No.: 14/847,337

(22) Filed: Sep. 8, 2015

Related U.S. Application Data
(60) Provisional application No. 62/047,988, filed on Sep. 9, 2014.

(51) Int. Cl. G06F 19/00

(52) U.S. Cl. CPC G06F 19/3437; G06F 19/3443

(57) ABSTRACT

Aspects of the disclosure provide a system for disease detection. The system includes an interface circuit, a memory circuit, and a disease detection circuitry. The interface circuit is configured to receive data events associated with a patient sampled at different time for disease detection. The memory circuit is configured to store configurations of a model for detecting a disease. The model is generated using machine learning technique based on time-series data events from patients that are diagnosed with/without the disease. The disease detection circuitry is configured to apply the model to the data events to detect an occurrence of the disease.

### INCORPORATION BY REFERENCE

This present disclosure claims the benefit of U.S. Provisional Application No. 62/047,988, “SEPSIS DETECTION ALGORITHM” filed on Sep. 9, 2014, which is incorporated herein by reference in its entirety.

### BACKGROUND

Early disease detection, such as sepsis detection, community acquired pneumonia (CAP) detection, clostridium difficile (CDF) infection detection, intra-amniotic infection (IAI) detection, and the like, can be critical. In an example, sepsis refers to a systemic response arising from infection. In the United States, 0.8 to 2 million patients become septic every year and hospital mortality for sepsis patients ranges from 18% to 60%. The number of sepsis-related deaths has tripled over the past 20 years due to the increase in the number of sepsis cases, even though the mortality rate has decreased. Delay in treatment is associated with mortality.

### SUMMARY

Aspects of the disclosure provide a system for disease detection. The system includes an interface circuit, a memory circuit, and a disease detection circuitry. The interface circuit is configured to receive data events associated with a patient sampled at different time for disease detection. The memory circuit is configured to store configurations of a model for detecting a disease. The model is generated using machine learning technique based on time-series data events from patients that are diagnosed with/without the disease. The disease detection circuitry is configured to apply the model to the data events to detect an occurrence of the disease.

According to an aspect of the disclosure, the memory circuit is configured to store the configuration of the model for detecting at least one of sepsis, community acquired pneumonia (CAP), clostridium difficile (CDF) infection, and intra-amniotic infection (IAI).

In an embodiment, the disease detection circuitry is configured to ingest the time-series data events from the patients that are diagnosed with/without the disease and build the model based on the ingested time-series data events. In an example, for a diagnosed patient with the disease, the disease detection circuitry is configured to select time-series data events in a first time duration before a time when the disease is diagnosed, and in a second time duration after the time when the disease is diagnosed. Further, the disease detection circuitry is configured to extract features from the time-series data events, and build the model using the extracted features.

In an example, the disease detection circuitry is configured to build the model using a random forest method. Further, the disease detection circuitry is configured to divide the time-series data events into a training set and a validation set, build the model based on the training set and validate the model based on the validation set.

In an example, the disease detection circuitry is configured to determine whether the data events associated with the patient are sufficient for disease detection, and store the data events in the memory circuit to wait for more data events when the present data events are insufficient.

Aspects of the disclosure provide a method for disease detection. The method includes storing configurations of a model for detecting a disease. The model is built using machine learning technique based on time-series data events from patients that are diagnosed with/without the disease. Further, the method includes receiving data events associated with a patient sampled at different time for disease detection, and applying the model to the data events to detect an occurrence of the disease on the patient.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a diagram of a disease detection platform 100 according to an embodiment of the disclosure;

FIG. 2 shows a block diagram of a disease detection system 220 according to an embodiment of the disclosure;

FIG. 3 shows a flow chart outlining a process example 300 for building a model for disease detection according to an embodiment of the disclosure; and

FIG. 4 shows a flow chart outlining a process example 400 for disease detection according to an embodiment of the disclosure.

### DETAILED DESCRIPTION OF EMBODIMENTS

The disclosed methods and systems below may be described generally, as well as in terms of specific examples and/or specific embodiments. For instances where references are made to detailed examples and/or embodiments, it is noted that any of the underlying principles described are not to be limited to a single embodiment, but may be expanded for use with any of the other methods and systems described herein as will be understood by one of ordinary skill in the art unless otherwise stated specifically.

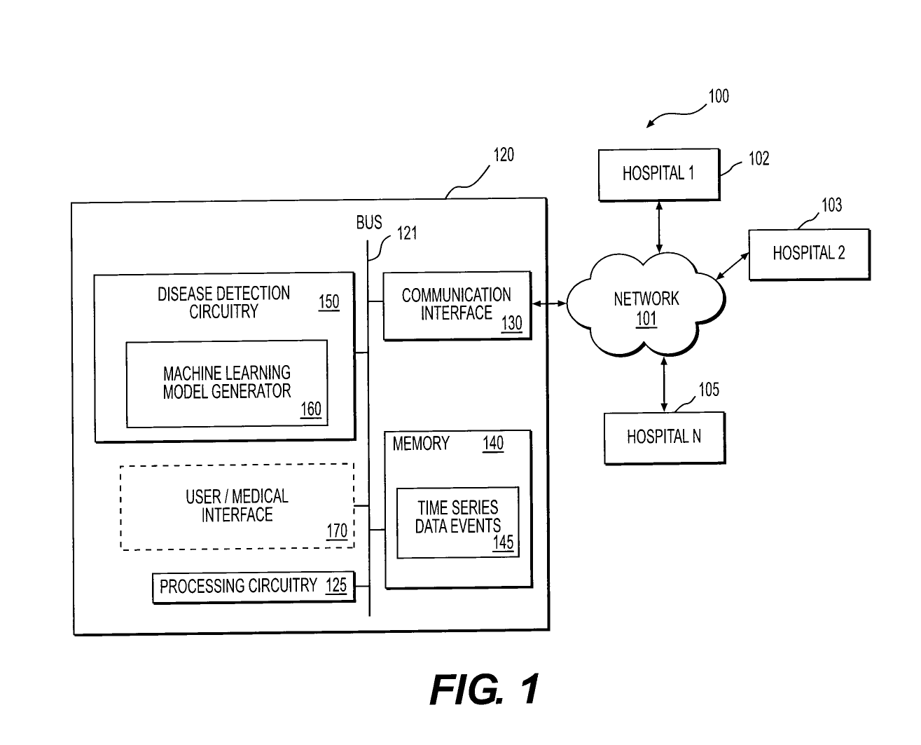

FIG. 1 shows a diagram of an exemplary disease detection platform 100 according to an embodiment of the disclosure. The disease detection platform 100 includes a disease detection system 120, a plurality of health care service providers 102-105, such hospitals, clinics, labs, and the like, and network infrastructure 101 (e.g., Internet, Ethernet, wireless network) that enables communication between the disease detection system 120 and the plurality of health care service providers 102-105. In an embodiment, the disease detection system 120 is configured to perform real-time disease detection based on a machine learning model that is generated based on time-series data events.

The disease detection platform 100 can be used in various disease detection services. In an embodiment, the disease detection platform 100 is used in sepsis detection. Sepsis refers to a systemic response arising from infection. In the United States, 0.8 to 2 million patients become septic every year and hospital mortality for sepsis patients ranges from 18% to 60%. The number of sepsis-related deaths has tripled over the past 20 years due to the increase in the number of sepsis cases, even though the mortality rate has decreased. Delay in treatment is associated with mortality. Hence, timely prediction of sepsis is critical.

In the embodiment, the disease detection system 120 receives real time patient information from the health care service providers 102-105, and predicts sepsis at real time based on a model built based on machine learning techniques. The real time patient information includes lab test, vital, and the like collected on patients over time by the health care service providers 102-105. According to an aspect of the disclosure, machine learning techniques can extract hidden correlations between large numbers of variables that would be difficult for a human to analyze. In an example, the machine learning model based prediction takes a short time, such as less than a minute, and can predict sepsis at an early stage, thus early sepsis treatment can be provided to the diagnosed patients.

In another embodiment, the disease detection platform 100 is used in community acquired pneumonia (CAP) detection. CAP is a lung infection resulting from the inhalation of pathogenic organisms. CAP can have a high mortality rate, particularly in the elderly and immunosuppressed patients. For these patient groups, CAP presents a grave risk. Three pathogens account for 85% of all CAP; these pathogens are: streptococcus pneumoniae, haemophilus influenzae, and moraxella catarrhalis. Diagnosis techniques that rely on manually intensive processes may take a relatively long time to determine if a patient has acquired pneumonia.

In the embodiment, the disease detection system 120 receives real time information, such as lab test, vital, and the like collected on patients over time from the health care service providers 102-105, and predicts CAP based on a model built based on machine learning techniques. In an example, the machine learning based CAP prediction takes a short time, such as less than a minute, and can predict CAP at an early stage, thus early treatment can be provided to the diagnosed patients.

In another embodiment, the disease detection platform 100 is used in clostridium difficile (CDF) infection detection. CDF is a gram positive bacterium that is a common source of hospital acquired infection. CDF is a common infection in patients undergoing long term post-surgery hospital stays. Without treatment, these patients can quickly suffer grave consequences from a CDF infection.

In the embodiment, the disease detection system 120 receives real time information, such as lab test, vital, and the like collected on patients over time from the health care service providers 102-105, and predicts CDF based on a model built based on machine learning techniques. In an example, the machine learning based CDF prediction takes a short time, such as less than a minute, and can predict CDF at an early stage, thus early treatment can be provided to the diagnosed patients.

In another embodiment, the disease detection platform 100 is used in intra-amniotic infection (IAI) detection. IAI is an infection of the amniotic membrane and fluid. IAI greatly increases the risk of neonatal sepsis. IAI is a leading contributor to febrile morbidity (10-40%) and neonatal sepsis/pneumonia (20-40%). Diagnosis methods that use thresholds compared to individual vital/lab values may have a relatively high false alarm rates and long lags for detection.

In the embodiment, the disease detection system 120 receives real time information, such as lab test, vital, and the like collected on patients over time from the health service providers 102-105, and predicts IAI based on a model built based on machine learning techniques. The machine learning based techniques loosen the reliance on any one vital/lab value, reduce detection time, improve accuracy, and provide cost saving benefit to hospitals.

In the FIG. 1 example, the disease detection system 120 includes a disease detection circuitry 150, a processing circuitry 125, a communication interface 130, and a memory 140. These elements are coupled together as shown in FIG. 1.

In an embodiment, the processing circuitry 125 is configured to provide control signals to other components of the system 100 to instruct the other components to perform desired functions, such as processing the received data sets, building a machine learning model, detecting disease, and the like.

The communication interface 130 includes suitable components and/or circuits configured to enable the disease detection system 120 to communicate with the plurality of health care service providers 102-105 in real time.

The memory 140 can include one or more storage media that provide memory space for various storage needs. In an example, the memory 140 stores code instructions to be executed by the disease detection circuitry 150 and stores data to be processed by disease detection circuitry 150. For example, the memory 140 includes a memory space 145 to store time series data events for one or more patients. In another example, the memory 140 includes a memory space (not shown) to store configurations for a model that is built based on machine learning techniques.

The storage media include, but are not limited to, hard disk drive, optical disc, solid state drive, read-only memory (ROM), dynamic random access memory (DRAM), static random access memory (SRAM), flash memory, and the like.

According to an aspect of the disclosure, the user/medical interface 170 is configured to visualize disease detection on a display panel. In an example, each patient is represented by a dot which moved along an X-axis in time and each event is characterized by a color based on the disease determination. For example, green is used for non-septic, yellow is used for possibly or likely septic, and red is used for very likely septic. When a number of septic events for a patient persist in time, the user/medical interface 170 provides an alert signal.

The disease detection circuitry 150 is configured to apply a model for detecting a disease to the time-series data events of a patient to detect an occurrence of the disease on the patient. In an example the model is built using machine learning techniques on time-series data events from patients that are diagnosed with/without the disease.

According to an aspect of the disclosure, the disease detection circuitry 150 includes a machine learning model generator 160 configured to build the model using the machine learning techniques. In an example, the machine learning model generator 160 builds the model using random forest method. For example, machine learning model generator 160 suitably processes the time-series data events from patients that are previously diagnosed with/without the disease to generate a training set of data. Based on the training set of data, the machine learning model generator 160 builds multiple decision trees. In an embodiment, a random subset of the training set is used to train a single decision tree. For example, the training set is uniformly sampled with replacement to generate bootstrap samples that form the random subset. The remaining unused data for the decision tree can be saved for later use, for example, to generate an ‘out of bootstrap’ error estimation.

Further, in the example, once the bootstrap samples are generated, at every node of the decision tree, a random subset of features (e.g., variables) is selected, and the optimal (axis parallel) split is scanned for on that subset of features (variables). Once the optimal split is found for the node, errors are calculated and recorded. Then, at a next node, the features are re-sampled and optical split for the next node is determined. After a tree is complete, the unused data not in the bootstrap sample can be used to generate the ‘out of bootstrap’ error for that decision tree. In the example, it can be mathematically shown that the average of the out of bootstrap error over the whole random forest is an indicator for the generalization error of the random forest.

The multiple decision trees form the random forest, and the random forest is used as the model for disease detection. In an example to use the random forest, each decision tree examines the data for a patient and determines its own classification or regression. The determinations are then averaged over the entire random forest to result in a single classification or regression.

The random forest method provides many benefits. In an example, a decision tree may over-fit data for generating the decision tree. The random forest method averages determinations from multiple decision trees, and thus provides a benefit of inherent resistance to over fitting the data.

According to an aspect of the disclosure, the decision trees can be generated in series and/or in parallel. In an example, the disease detection circuitry 120 includes multiple processing units that can operate independently. In the example, the multiple processing units can operate in parallel to generate multiple decision trees. It is noted that, in an example, the multiple processing units are integrated in, for example an integrated circuit (IC) chip. In another example, the multiple processing units are distributed, for example, in multiple computers, and are suitably coupled together to operate in parallel.

Further according to an aspect of the disclosure, the performance of the machine learning model can be suitably adjusted. In an example to detect septic, when the number of non-septic patents in the training set for generating the machine learning model increases, the false alarm rate decreases.

It is noted that although a bus 121 is depicted in the example of FIG. 1 to couple various components together, in another example, other suitable architecture can be used to couple the various components together. In an example, the disease detection circuitry 150 can be realized using dedicated processing electronics interconnected by separate control and/or data buses embedded in one or more Application Specific Integrated Circuits (ASICs). In another example, the disease detection circuitry 150 is integrated with the processing circuitry 125.

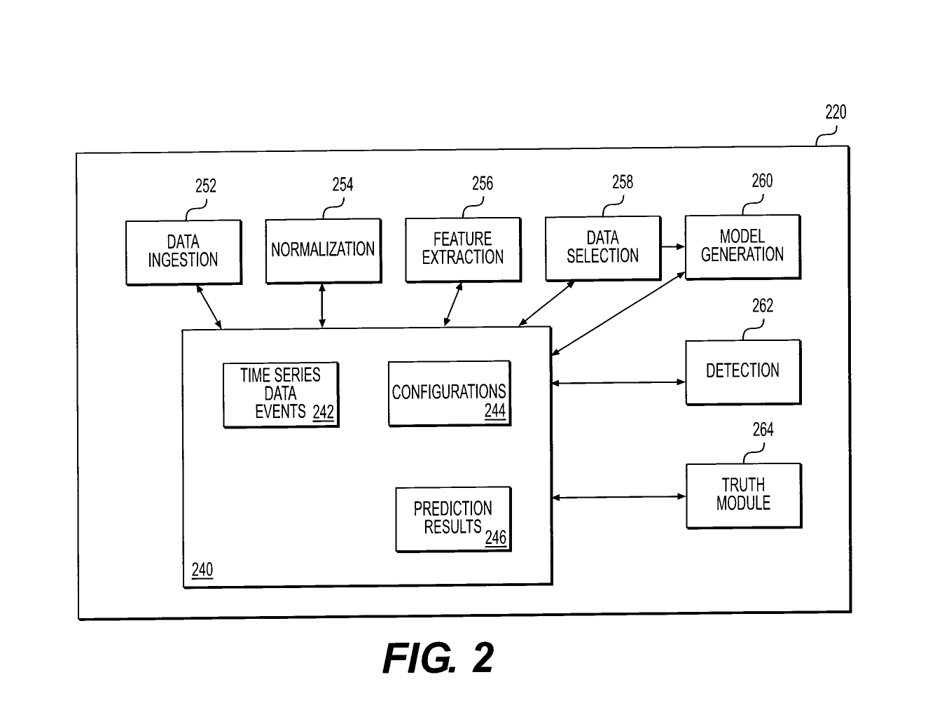

FIG. 2 shows a block diagram of disease detection system 220 according to an embodiment of the disclosure. In an example, the disease detection system 220 is used in the disease detection platform 100 in the place of the disease detection system 120.

The disease detection system 220 includes a plurality of components, such as a data ingestion component 252, a normalization component 254, a feature extraction component 256, a data selection component 258, a model generation component 260, a detection component 262, a truth module 264, a database 240, and the like. These components are coupled together as shown in FIG. 2.

In an embodiment, one or more components, such as the model generation component 260, the detection component 262, and the like, are implemented using circuitry, such as application specific integrated circuit (ASIC), and the like. In another embodiment, the components are implemented using a processing circuitry, such as a central processing unit (CPU) and the like, executing software instructions.

The database 240 is configured to suitably store information in suitable formats. In the FIG. 2 example, the database 240 stores time-series data events 242 for patients, configurations 244 for models and prediction results 246.

The data ingestion component 252 is configured to properly handle and organize incoming data. It is noted that the incoming data can have any suitable format. In an embodiment, an incoming data unit includes a patient identification, a time stamp, vital or lab categories and values associated with the vital or lab categories. In an example, before a patient is moved into an intensive care unit (ICU), each data unit includes a patient identification, a time stamp when data is taken, both vital and lab categories, such as demographics, blood orders, lab results, respiratory rate (RR), heart rate (HR), systolic blood pressure (SBP), and temperature; and after a patient is moved into the ICU, each data unit includes a patient identification, a time stamp, and lab categories.

In an embodiment, when the data ingestion component 252 receives a data unit for a patient, the data ingestion component 252 extracts, from the data unit, a patient identification that identifies the patient, a time stamp that indicates when data is taken on the patient, and values for the vital or lab categories. When the data unit is a first data unit for the patient, the data ingestion component 252 creates a record in the database 240 with the extracted information. When a record exists in the database 240 for the patient, the data ingestion component 252 updates the record with the extracted information.

Further, in an embodiment, the data ingestion component 252 is configured to determine whether the record information is insufficient for disease detection. In an example, the data ingestion component 252 calculates a completeness measure for the record. When the completeness measure is lower than a predetermined threshold, such as 30%, and the like, the data ingestion component 252 determines that the record information is insufficient for disease detection.

In an embodiment, the data ingestion component 252 is configured to identify a duplicate record for a patient, and remove the duplicate record.

The normalization component 254 is configured to re-format the incoming data to assist further processing. In an example, hospitals may not use standardized data format, the normalization component 254 re-formats the incoming data to have a same format. The normalization component 254 can perform any suitable operations, such as data rejection, data reduction, unit conversions, file conversions, and the like to re-format the incoming data.

In an example, the normalization component 254 can perform data rejection that rejects data which is deemed to be insufficiently complete for use in the disease detection. Using insufficiently complete data can negatively impact the performance and reliability of the platform, thus data rejection is necessary to ensure proper operation. The normalization component 254 can perform data reduction that removes unnecessary or unused data, and compress data for storage. The normalization component 254 can perform unit conversion that unifies the units. The normalization component 254 can perform file conversions that converts data from one digital format into a digital format selected for use in the database 240. Further, the normalization component 254 can perform statistical normalization or range mapping.

The feature extraction component 256 is configured to extract important information from the received data. According to an aspect of the disclosure, data may include irrelevant information, duplicate information, unhelpful noise, or simply too much information to process in the available time constraints. The feature extraction component 256 can extract the important information, and reduce the overall data size while retaining relationships necessary to train an accurate model. Thus, model training takes less memory space and time.

In an example, the feature extraction component 256 uses spectral manifold learning to extract features. The spectral manifold learning techniques uses spectral decomposition to extract low-dimensional structure from high dimensional data. The spectral manifold model offers the benefit of visual representation of data by extracting important components from the data in a principled way. For example, the structure or distance relationships are mostly preserved using the spectral manifold model. The data gets mapped into a space that is visible to humans, which can be used to show vivid relationships in the data.

In another example, the feature extraction component 256 uses principal component analysis (PCA). For example, based on an idea that features with higher variance has higher importance to a machine learning based prediction, PCA is used to derive a linear mapping from a high dimensional space to a lower dimensional space. In an example, eigenvalue analysis of the covariance matrix of data is used to derive the linear mapping. PCA can be highly effective in eliminating redundant correlation in the data.

In the example, PCA can also be used to visualize data by mapping, for example, the first two or three principal component directions.

The data selection component 258 is configured to select suitable data events for training and test purposes in an example. In an example to build a model for sepsis detection, a time to declare a patient septic is critical. In the example, for a patient who is declared to be septic, a time duration that includes 6 hours prior to the declaration of septic by a doctor and up to 48 hours after the declaration is used to define septic events. Each data point in this time duration for the patient who is declared septic is a septic event. Other data points from patients who are declared to be non-septic are non-septic events.

Further, in an example, the septic events and non-septic events are sampled randomly to separate into a training set and a test set. Thus, both sets may have events from a same patient.

The model generation component 260 is configured to generate a machine learning model based on the training set. In an example, the model generation component 260 is configured to generate the machine learning model using a random forest method. In an example, according to the random forest method, multiple decision trees are trained based on the training set. Each decision tree is generated based on a subset of the training set. For example, when training a single decision tree, a random subset of the training set is used. In an example, the training set is uniformly sampled with replacement to generate bootstrap samples that form the random subset. The remaining unused data for the decision tree can be saved for later use in generating an ‘out of bootstrap’ error estimate.

Further, in the example, once the bootstrap samples are generated, at every node of the decision tree, a random subset of features (e.g., variables) is selected, and the optimal (axis parallel) split is scanned for on that subset of features (variables). Once the optimal split is found for the node, errors are calculated and recorded. Then, at a next node, the features are re-sampled and optical split for the next node is determined. After a tree is complete, the unused data not in the bootstrap sample can be used to generate the ‘out of bootstrap’ error for that decision tree. In the example, it can be mathematically shown that the average of the out of bootstrap error over the whole random forest is an indicator for the generalization error of the random forest.

The multiple decision trees form the random forest, and the random forest is used as the model for disease detection. In an example to use the random forest, each decision tree examines the data for a patient and determines its own classification or regression. The determinations are then averaged over the entire random forest to result in a single classification or regression.

In an example, the model generation component 260 includes multiple processing units, such as multiple processing cores and the like, that can operate independently. In the example, the multiple processing cores can operate in parallel to generate multiple decision trees.

Further, when the random forest method is used in the model generation component 260, the random forest can be used to perform other suitable operations. In an example, for each pair of data points in the data, the random forest method assigns a proximity counter. For each decision tree in which the two points end up in a terminal node, their proximity counter is increased by 1 vote. Data with higher proximity can be thought of to be ‘closer’ or ‘similar’ to other data. In an example, the information provided by the proximity counters can be used to perform clustering, outlier detection, missing data imputation, and the like, operations.

For example, a missing value can be imputed based on nearby data with higher values in the proximity counter. In an example, an iterative process can be used to repetitively impute a missing value, and re-grow the decision tree until the decision tree satisfies a termination condition.

It is noted that the model generation component 260 can use other suitable method, such as a logistic regression method, a mix model ensemble method, a support vector machine method, a K nearest neighbors method and the like.

Further, in an example, the model generation component 260 also validates the generated model. For example, the model generation component 260 uses a K-fold cross-validation. In an example, in a 10-fold cross validation, a random 1/10 th of the data is omitted during a training process of a model. After the completion of the training process, 1/10 th of the data can serve as a test set to determine the accuracy of the model, and this process can repeat for 10 times. It is noted that the portion of data omitted need not be 1/K, but can reflect the availability of the data. Using this technique, a good estimate for how a model will perform on real data can be determined.

In addition, in an example, the model generation component 260 is configured to conduct a sensitivity analysis of the model to variables. For example, when a model's accuracy is highly sensitive to a perturbation in a given variable in its training data, thus the model has a relatively high sensitivity to that variable, and the variable is likely to be relatively important to the predictions using the model.

The detection component 262 is configured to apply the generated model on incoming data for a patient to detect disease. In an example, the detection result is visualized via, for example the user/medical interface 170 to health care provider. When the detection results alert, for example, high possibility sepsis for a patient, the health care provider can lab results to confirm the detection. In an example, the lab results can be sent back to the disease detection system 220.

The truth module 264 is configured to receive the lab results, and update the data based on the confirmation information. In an example, the updated can be used to rebuild the model.

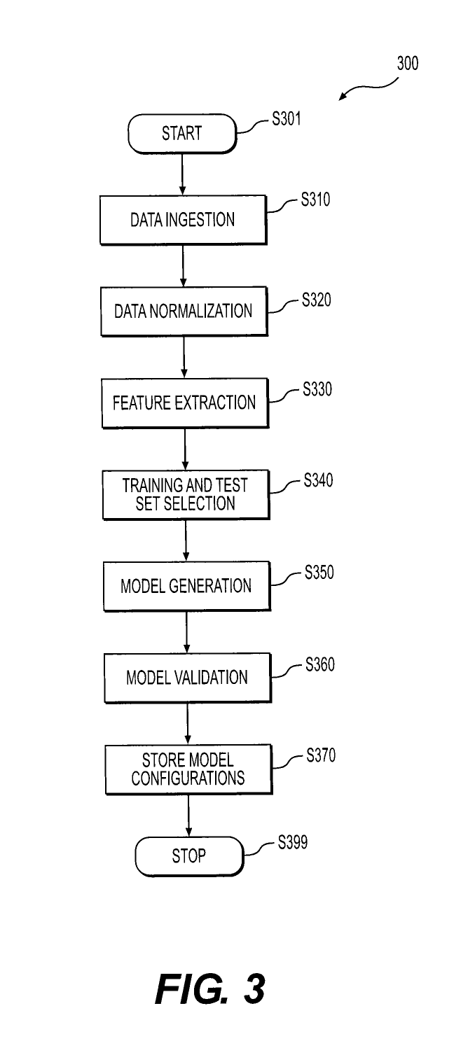

FIG. 3 shows a flow chart outlining a process 300 to build a model for disease detection according to an embodiment of the disclosure. In an example, the process is executed by a disease detection system, such as the disease detection system 120, the disease detection system 220, and the like. The process starts at S301 and proceeds to S310.

At S310, data is ingested in the disease detection system. In an example, the incoming data can come from various sources, such as hospitals, clinics, labs, and the like, and may have different formats. The disease detection system properly handles and organizes the incoming data. In an example, the disease detection system extracts, from the incoming data, a patient identification that identifies a patient, a time stamp that identifies when data is taken from the patient, and values for the vital or lab categories. When the data unit is a first data unit for the patient, the disease detection system creates a record in a database with the extracted information. When a record exists in the database for the patient, the disease detection system updates the record with the extracted information.

Further, in an example, the disease detection system determines whether the record information is insufficient for disease detection. In an example, the disease detection system calculates a completeness measure for the record. When the completeness measure is lower than a predetermined threshold, such as 30%, and the like, the disease detection system determines that the record information is insufficient for disease detection.

At S320, data is normalized in the disease detection system. In an example, the disease detection system re-formats the incoming data to assist further processing. In an example, hospitals may not use standardized data format, the disease detection system reformats the incoming data to have the same format.

Further, in the example, the disease detection system can perform data rejection that rejects data which is deemed to be insufficiently complete for use in the disease detection. The disease detection system can perform unit conversion that unifies the units. The disease detection system can perform file conversions that converts data from one digital format into a digital format selected for use in the database. Further, the disease detection system can perform statistical normalization or range mapping.

At S330, features are extracted from the database. In an example, the disease detection system extracts the important information (features), and reduces the overall data size while retaining the relationships necessary to train an accurate model. Thus, model training takes less memory space and time.

In an example, the disease detection system uses spectral manifold model. In another example, the disease detection system uses principal component analysis (PCA).

At S340, training and test data sets are selected. In an example, the disease detection system selects suitable datasets for training and test purposes. In an example to build a model for sepsis detection, a time to declare a patient septic is critical. In the example, for a patient who is declared to be septic, a time duration that includes 6 hours prior to the declaration of septic by a doctor and up to 48 hours after the declaration is used to define septic events. Each data point in this time duration for the patient who is declared septic is a septic event. Other data points from patients who are not declared to be septic are non-septic events.

Further, in an example, the septic events and non-septic events are sampled randomly to separate into a training set and a test set. Thus, both sets may have events from a same patient.

At S350, a machine learning model is generated based on the training set. In an example, the disease detection system generates the machine learning model using a random forest method. The random forest method builds multiple decision trees based on the training set of data.

In an embodiment, a random subset of the training set is used to train a single decision tree. For example, the training set is uniformly sampled with replacement to generate bootstrap samples that form the random subset. The remaining unused data for the decision tree can be saved for later use, for example, to generate an ‘out of bootstrap’ error estimation.

Further, in the example, once the bootstrap samples are generated, at every node of the decision tree, a random subset of features (e.g., variables) is selected, and the optimal (axis parallel) split is scanned for on that subset of features (variables). Once the optimal split is found for the node, errors are calculated and recorded. Then, at a next node, the features are re-sampled and optical split for the next node is determined. After a decision tree is complete, the unused data not in the bootstrap sample can be used to generate the ‘out of bootstrap’ error for that decision tree. In the example, it can be mathematically shown that the average of the out of bootstrap error over the whole random forest is an indicator for the generalization error of the random forest.

The multiple decision trees form the random forest, and the random forest is used as the model for disease detection. In an example to use the random forest, each decision tree examines the data for a patient and determines its own classification or regression. The determinations are then averaged over the entire random forest to result in a single classification or regression.

In an example, the disease detection system includes multiple processing units, such as multiple processing cores and the like, that can operate independently. In the example, the multiple processing cores can operate in parallel to generate multiple decision trees.

At S360, the model is validated. In an example, the disease detection system uses a K-fold cross-validation. For example, in a 10-fold cross validation, a random 1/10 th of the data is omitted during a training process of a model. After the completion of the training process, 1/10 th of the data can serve as a test set to determine the accuracy of the model, and this process can repeat for 10 times. It is noted that the portion of data omitted need not be 1/K, but can reflect the availability of the data. Using this technique, a good estimate for how a model will perform on real data can be determined.

In addition, in an example, the disease detection system is configured to conduct a sensitivity analysis of the model to variables. For example, when a model's accuracy is highly sensitive to a perturbation in a given variable in its training data, thus the model has a relatively high sensitivity to that variable, and the variable is likely to be relatively important to the predictions using the model.

At S370, the model and configurations are stored in the database. The stored model and configurations are then used for disease detection. Then the process proceeds to S399 and terminates.

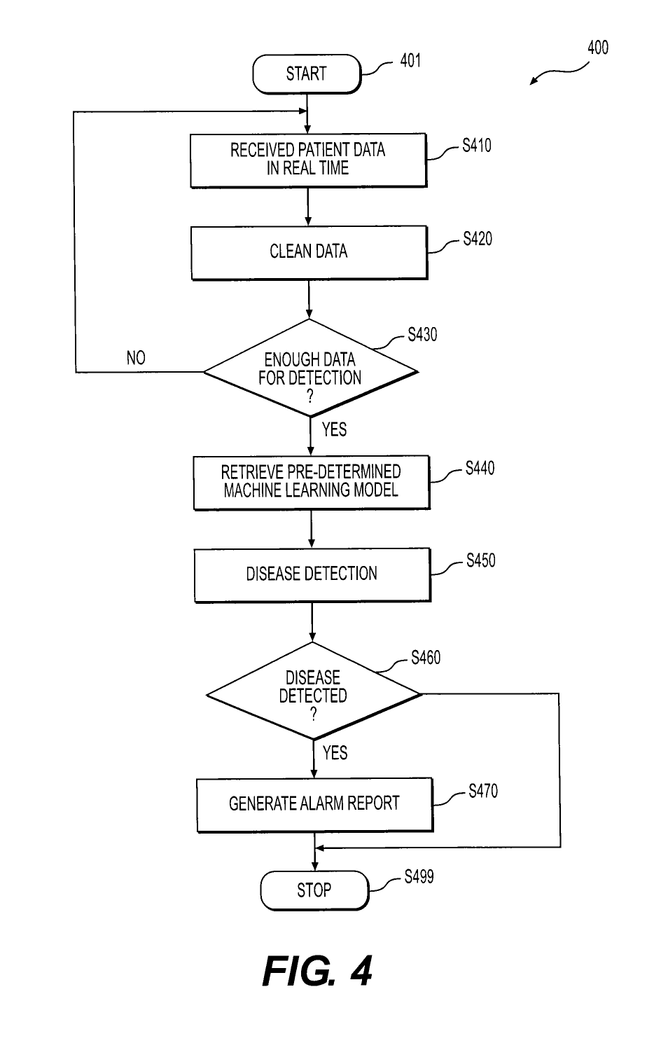

FIG. 4 shows a flow chart outlining a process 400 for disease detection according to an embodiment of the disclosure. In an example, the process is executed by a disease detection system, such as the disease detection system 120, the disease detection system 220, and the like. The process starts at S401 and proceeds to S410.

At S410, patient data is received in real time. In an example, each time when vital data is measured or lab results are available for a patient, the vital data and the lab results are sent to the disease detection system via a network.

At S420, the data is cleaned. In an example, the patient data is re-formatted. In another example, the unites in the patient data are converted. In another example, invalid values in the patient data are identified and removed. The data can be organized in a record that includes previously received data for the patient.

At S430, the disease detection system determines whether the patient data is enough for disease detection. In an example, the disease detection system determines a completeness measure for the record, and determines whether the patient data is enough based on the completeness measure. When the patient data is sufficient for disease detection, the process proceeds to S440; otherwise, the process returns to S410 to receive more data for the patient.

At S440, the disease detection system retrieves pre-determined machine learning model. In an example, configurations of the machine learning model are stored in a memory. The disease detection system reads the memory to retrieve the machine learning model.

At S450, the disease detection system applies the machine learning model on the patient data to classify the patient. In an example, the machine learning model is a random forest model that includes multiple decision trees. The multiple decision trees are used to generate respective classifications for the patient. Then, in an example, the respective classifications are suitably averaged to make a unified classification for the patient.

At S460, when the classification indicates a possible occurrence of disease, the process proceeds to S470; otherwise the process proceeds to S499 and terminates.

At S470, the disease detection system generates an alarm report. In an example, the disease detection system provides a visual alarm on a display panel to alert health care service provider. The health care service provider can take suitable actions for disease treatment. Then, the process proceeds to S499 and terminates.

When implemented in hardware, the hardware may comprise one or more of discrete components, an integrated circuit, an application-specific integrated circuit (ASIC), etc.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A system for disease detection, comprising:
an interface circuit configured to receive data events associated with a patient sampled in time series for disease detection;
a memory circuit configured to store configurations of a model for detecting a disease, the model being machine-learned based on time-series data events from patients that are diagnosed with/without the disease; and
a disease detection circuitry configured to apply the model to the data events to detect an occurrence of the disease.

2. The system of claim 1, wherein the memory circuit is configured to store the configuration of the model for detecting at least one of sepsis, community acquired pneumonia (CAP), clostridium difficile (CDF) infection, and intra-amniotic infection (IAI).

3. The system of claim 1, wherein the disease detection circuitry is configured to ingest the time-series data events from the patients that are diagnosed with/without the disease and build the model based on the ingested time-series data events.

4. The system of claim 3, wherein, for a diagnosed patient with the disease, the disease detection circuitry is configured to select time-series data events in a first time duration before a time when the disease is diagnosed, and in a second time duration after the time when the disease is diagnosed.

5. The system of claim 3, wherein the disease detection circuitry is configured to extract features from the time-series data events, and build the model using the extracted features.

6. The system of claim 3, wherein the disease detection circuitry is configured to build the model using a random forest method.

7. The system of claim 3, wherein the disease detection circuitry is configured to divide the time-series data events into a training set and a validation set, build the model based on the training set and validate the model based on the validation set.

8. The system of claim 1, wherein the disease detection circuitry is configured to determine whether the data events associated with the patient are sufficient for disease detection, and store the data events in the memory circuit to wait for more data events when the present data events are insufficient.

9. A method for disease detection, comprising:
storing configurations of a model for detecting a disease, the model being machine-learned based on time-series data events from patients that are diagnosed with/without the disease;
receiving data events associated with a patient sampled at different time for disease detection; and
applying the model to the data events to detect an occurrence of the disease on the patient.

10. The method of claim 9, wherein storing configurations of the model for detecting the disease further comprises:
storing the configuration of the model for detecting at least one of sepsis, community acquired pneumonia (CAP), clostridium difficile (CDF) infection, and intra-amniotic infection (IAI).

11. The method of claim 9, further comprising:
ingesting the time-series data events from the patients that are diagnosed with/without the disease; and
building the model based on the ingested time-series data events.

12. The method of claim 11, further comprising:
selecting, for a diagnosed patient with the disease, the time-series data events in a first time duration before a time when the disease is diagnosed, and in a second time duration after the time when the disease is diagnosed.

13. The method of claim 11, further comprising:
extracting features from the time-series data events; and
building the model using the extracted features.

14. The method of claim 11, further comprising:
building the model using a random forest method.

15. The method of claim 11, further comprising:
dividing the time-series data events into a training set and a validation set;
building the model based on the training set; and
validating the model based on the validation set.

16. The method of claim 9, further comprising:
determining whether the data events associated with the patient are sufficient for disease detection; and
storing the data events in the memory circuit to wait for more data events when the present data events are insufficient.
